(19) United States
(12) Patent Application Publication
(10) Pub. No.: US 2026/0040282 A1
(43) Pub. Date: Feb. 5, 2026

(54) OPTIMIZING MEDIA ACCESS CONTROL AND PHYSICAL LAYER TRANSMISSION TIMING RELATIONSHIPS IN WIRELESS COMMUNICATION

(71) Applicant: TP-LINK SYSTEMS, INC., Irvine, CA (US)

(72) Inventors: Seong Park, San Jose, CA (US); Mao Yu, San Jose, CA (US); Yong Ma, San Jose, CA (US); Tianan Ma, San Jose, CA (US); Sonali Bagchi, San Jose, CA (US)

(73) Assignee: TP-LINK SYSTEMS, INC., Irvine, CA (US)

(21) Appl. No.: 18/790,515

(22) Filed: Jul. 31, 2024

(51) Int. Cl. H04W 72/0446

(52) U.S. Cl. CPC H04W 72/0446

(57) ABSTRACT

Techniques described herein relate to methods and apparatuses for communicating in a wireless communication network via the over the air (OTA) medium. In some embodiments, an apparatus may receive a frame while the OTA medium is busy. The apparatus may pre-configured the device to transmit a response before receiving the last symbol of the frame. In some embodiments, an apparatus waiting for transmission opportunity during a backoff period may determine to transmit before the last slot time interval at the end of the backoff period. The techniques may be implemented in a media access control layer (MAC) of the apparatus.

### FIELD

This technology relates to wireless communication network, and more particularly to systems and methods for media access control.

### BACKGROUND

Wireless local area network (WLAN) protocols, such as Institute for Electrical and Electronics Engineers (IEEE) 802.11, allow for various devices (stations) to communicate with each other in a wireless communication network. Whereas the protocols specify the signaling in over the air (OTA) medium, many underlying implementation details in devices are left to the device manufacturers. For example, the implementation of media access control (MAC) layer may be largely vendor specific as implementation details of the MAC may depend on the physical (PHY) layer characteristics, such as the delay in sensing whether the OTA medium is busy.

### SUMMARY

The present disclosure relates to techniques for optimizing MAC and PHY layer transmission timing relationships in wireless communication. In an embodiment, the techniques provide a software and/or hardware implemented method for communicating packets in a wireless communication network, the method comprising, at a device: receiving a first portion of a frame from an OTA medium at a first time; receiving a last portion of the frame from the OTA medium at a second time after the first time; determining, at a third time after the first time and before the second time, based at least in part on the first portion of the frame, whether one or more conditions for transmitting a response are met; and in response to determining that the one or more conditions for transmitting a response are met: (1) pre-configuring the device to transmit the response before the second time; and (2) transmitting the response to the OTA medium after the second time. Otherwise, in response to determining that the one or more conditions for transmitting a response are not met, the method ignores the frame.

In an embodiment, the techniques provide an apparatus for communication in a wireless network, the apparatus comprising one or more processors configured to perform one or more operations comprising: receiving a first portion of a frame from an OTA medium at a first time; receiving last portion of the frame from the OTA medium at a second time after the first time; determining, at a third time after the first time and before the second time, based at least on the first portion of the frame, whether one or more conditions for transmitting a response are met; and in response to determining that the one or more conditions are met: (1) pre-configuring the apparatus to transmit the response before the second time; and (2) transmitting the response to the OTA medium after the second time. Otherwise, in response to determining that the one or more conditions for transmitting a response are not met, the one or more operations include ignoring the frame.

In an embodiment, the techniques provide a method for communicating packets in a wireless communication network, the method comprising, at a device: at a first slot time interval for an OTA medium prior to a backoff counter for the device expiring, determining whether the OTA medium is busy; in response to determining that the OTA medium at the first slot time interval is not busy: (1) determining information for transmission; (2) at a second slot time interval for the OTA medium with the backoff counter for the device expired, determining whether the OTA medium at the second slot time interval is busy; (3) pre-configuring the device to transmit the information for transmission independent of determining whether the OTA medium at the second slot time interval is busy; and (4) in response to determining that the OTA medium is not busy, transmitting to the OTA medium after an end of the second slot time interval. In response to determining that the OTA medium at the first slot time interval is busy, the method ignores the first slot time interval.

In an embodiment, the techniques provide an apparatus for communicating in a wireless communication network, the apparatus comprising one or more processors configured to perform one or more operations comprising: at a first slot time interval for an OTA medium prior to a backoff counter for the apparatus expiring, determining whether the OTA medium is busy; in response to determining that the OTA medium at the first slot time interval is not busy: (1) determining information for transmission; (2) at a second slot time interval for the OTA medium with the backoff counter for the apparatus expired, determining whether the OTA medium at the second slot time interval is busy; (3) pre-configuring the apparatus to transmit the information for transmission independent of determining whether the OTA medium at the second slot time interval is busy; and (4) in response to determining that the OTA medium is not busy, transmitting to the OTA medium after an end of the second slot time interval. In response to determining that the OTA medium at the first slot time interval is busy, the one or more operations include ignoring the first slot time interval.

### BRIEF DESCRIPTION OF DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 illustrates a wireless communication network, according to some embodiments.

FIG. 2A is a timing diagram showing PHY layer delay in an initial interframe space interval, according to some embodiments.

FIG. 2B is a timing diagram showing PHY layer delay in a slot time interval, according to some embodiments.

FIG. 3A is a timing diagram showing optimized timing relationship between the MAC and PHY layers, where a response is prepared in the MAC layer before receiving the last symbol in a frame, according to some embodiments.

FIG. 3B shows detailed implementation of the timing diagram shown in FIG. 3A, according to some embodiments.

FIG. 4 is a flow diagram of an example process for implementing at least in part the timing diagram shown in FIGS. 3A-3B, according to some embodiments.

FIG. 5A is a timing diagram showing optimized timing relationship between the MAC and PHY layers, where information for transmission opportunity is prepared in the MAC layer before checking the last slot time interval at the end of the backoff period, according to some embodiments.

FIG. 5B is a variation of the timing diagram shown in FIG. 5A, according to some embodiments.

FIG. 5C shows detailed implementation of a timing diagram that may apply to FIGS. 5A and 5B, according to some embodiments.

FIG. 6 is a flow diagram of an example process for implementing at least in part the timing diagrams shown in FIGS. 5A-5C, according to some embodiments.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended. It should be further appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect. In the present disclosure, the MAC and the MAC layer may be interchangeable. The PHY and the PHY layer may be interchangeable.

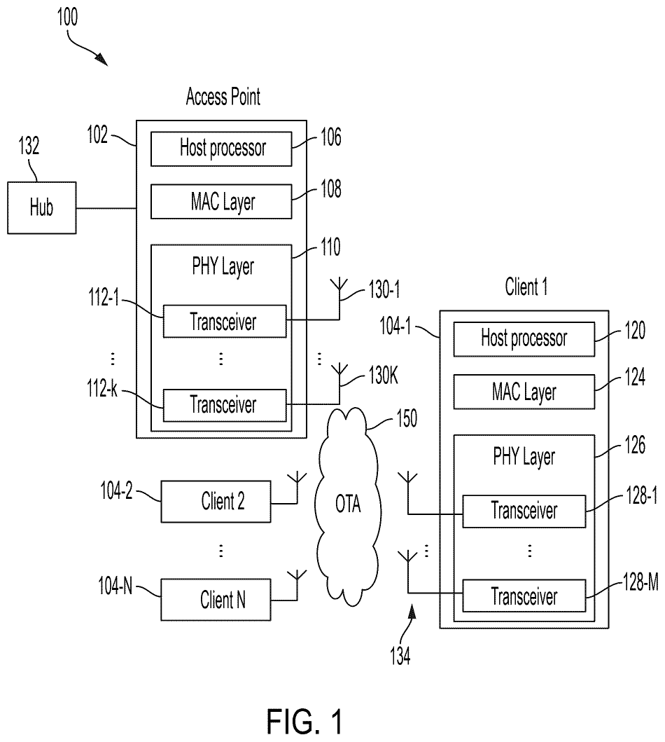

FIG. 1 illustrates a wireless communication network, according to some embodiments. In some embodiments, a wireless communication network 100 (e.g., WLAN) may facilitate communications between one or more access point (AP) device (e.g., 102) and one or more client devices (e.g., 104-1, 104-2, . . . 104-N). Each of the AP and client devices may be configured to receive or transmit frames (packets) from/to another device (e.g., AP or client devices) via over the air (OTA) medium (e.g., 150). These communication devices may be communicating with each other in a communication protocol, e.g., IEEE 802.11, or other suitable wireless protocols.

As shown in FIG. 1, AP device 102 may include one or more antennas (e.g., 130-1, . . . 130-K) configured to transmit or receive radio frequency (RF) signals to/from other devices in the wireless communication network 100. AP device 102 may include a PHY layer 110, a MAC layer 108, and a host processor 106, which are configured to generate or process RF signals in lower to upper network layers, respectively. For example, PHY 110 may be configured to implement physical layer functions. PHY 110 may also include one or more transceivers (e.g., 112-1, . . . 112-K) configured to convert between baseband signals and RF signals, where RF signals are transmitted or received via the one or more antennas, e.g., 130-1, . . . 130-K. In a non-limiting example, in 802.11, PHY 110 may be configured to receive wireless frames, e.g., MPDU (MAC protocol data unit) from the MAC, remove the preamble and PHY header and extract the baseband signals. Similarly, PHY 110 may add the preamble and the PHY header to the baseband signals to generate wireless frames (packets), e.g., MPDUs, for passing to the MAC layer.

In FIG. 1, MAC 108 may be configured to implement MAC layer functions including processing frames (packets) received from the PHY layer and converting to data frames for upper layer(s), or vice versa. For example, in 802.11, MAC 108 may extract MSDUs (MAC service data unit) payload encapsulated in the frame body of MPDUs for the upper layers, where MPDUs are received from the PHY layer. Similarly, MAC 108 may receive MSDUs from upper layers and convert them to MPDUs for the PHY layer. Host processor 106 may be coupled to MAC 108 and PHY 110 to process data via respective layers. Host processor 106 may also be configured to implement one or more applications and transmit/receive data to/from MAC 108.

As shown in FIG. 1, each of the components, e.g., host processor 106, MAC 108, PHY 110, as well as transceivers (112-1, . . . 112-K) may include circuitry, e.g., one or more integrated circuits (ICs). Thus, one or more functions of the MAC and PHY layers may be implemented in hardware. Alternatively, and/or additionally, one or more functions of the MAC and PHY layers may be implemented in software, e.g., via executing programing instructions (e.g., stored in memory). For example, each of MAC 108 and PHY 110 may include one or more processors, e.g., CPUs, to execute programming instructions in a memory.

With further reference to FIG. 1, AP device 102 may be connected to a hub 132 (e.g., a wired router, a modem) which provides the Internet services (e.g., via an ISP). AP device 102 may provide Internet, via hub 132, to one or more client devices (e.g., 104-1, 104-2, . . . 104-N) that are connected to the AP device wirelessly, e.g., via OTA medium 150. Each of the client devices may have a similar configuration as the AP device 102. For example, client device 104-1 may include a host processor 120, a MAC layer 124, a PHY layer 126.

Similar to AP device 102, a client device (e.g., 104-1, 104-2, . . . 104-N) may include one or more antennas (e.g., 134) configured to transmit or receive RF signals to/from other devices in the wireless communication network 100. PHY layer 126, MAC layer 124, and host processor 120 may be configured to generate or process RF signals in lower to upper network layers, respectively. For example, PHY layer 126 may be configured to implement physical layer functions. PHY layer 126 may include one or more transceivers (e.g., 128-1, . . . 128-M) configured to convert between baseband signals and RF signals, where RF signals are transmitted or received via the one or more antennas 134. In a non-limiting example, in 802.11, PHY layer 126 may receive wireless frames, e.g., MPDUs from MAC layer 124, remove the preamble and PHY header and extract the baseband signals. Similarly, PHY 126 may add the preamble and the PHY header to the baseband signals to generate wireless frames (packets), e.g., MPDUs, for passing to MAC layer 124.

In FIG. 1, MAC layer 124 may be configured to implement MAC layer functions including processing frames (packets) received from the PHY layer and converting to data frames for upper layer(s), or vice versa. For example, in 802.11, the MAC layer may extract MSDUs payload encapsulated in the frame body of MPDUs for the upper layers, where MPDUs are received from the PHY layer. Similarly, the MAC layer may receive MSDUs from the upper layers and convert them to MPDUs for the PHY layer. Host processor 120 may be coupled to MAC layer 124 and PHY layer 126 to process data via respective layers. Host processor 120 may also be configured to implement one or more applications and transmit/receive data to/from MAC layer 124.

Similar to AP device 102, each of the components in a client device, e.g., host processor 120, MAC layer 124, PHY layer 126, as well as transceivers (128-1, . . . 128-M) may include circuitry, e.g., one or more integrated circuits (ICs). Thus, one or more functions of MAC and PHY layers may be implemented in hardware. Alternatively, and/or additionally, one or more functions of the MAC and PHY layers may be implemented in software, e.g., via executing programing instructions (e.g., stored in memory) by MAC layer 124, PHY layer 126, host processor 120, or any other suitable processors. Client devices 104-2, . . . 104-N may each have a similar configuration as client device 104-1. Although one AP device 102 is shown in FIG. 1, it is appreciated that there can be multiple AP devices in the wireless communication network 100. Further, any suitable number of client device may be possible as supported in current or later developed protocols.

In some embodiments, to avoid collision among devices as shown in FIG. 1 (e.g., AP device or client device), each device contending for the OTA medium may be configured to synchronize with the OTA medium (e.g., via a clock in each device), as measured by space time frame. For example, 802.11 protocols define two types of space time: short interframe space (SIFS) and slot time. Various 802.11 protocols may define different values for SIFS and slot time intervals. For example, SIFS may be an interval of 16 μs. Slot time (slotTime) may be an interval of 9 μs, in a given 802.11 variation. It is appreciated that SIFS and slotTime may have other values. In some embodiments, a device in the wireless communication network may check whether the OTA medium is busy or idle.

In some embodiments, a device may be permitted to transmit a frame when certain conditions are met. For example, a frame may be transmitted by one device via the OTA medium while it is received by a receiver device. When this happens, the OTA medium is busy. In some embodiments, a frame that is transmitted by a sender device may be broadcasted to other devices in the wireless network, where only one or more devices of the devices receiving the frame are intended receiver device(s). For example, a device may be in a receiving mode when the OTA medium is busy, and may receive the frame transmitted from the sender device. Once the transmission is complete (the OTA medium becomes idle), the device receiving the frame may determine, based on the received frame, whether the device itself is the intended receiver device. This may be determined by the device by checking a field in the received frame. For example, a MAC header field of the received frame may include an address indicating the MAC address of the intended receiver device.

A device receiving a frame via OTA medium may check whether the device itself is the intended receiver device of the frame (e.g., by comparing the MAC header field in the frame to the MAC address of the device itself). If the MAC header field in the frame matches the MAC address of the receiving device, the device may determine that the received frame is intended for the device itself. In this case, the device may be permitted to transmit an immediate response (IR) to the received frame within the SIFS interval after the time the OTA medium becomes idle (e.g., at the end of OTA medium being busy). If the receiving device determines that the received frame is intended for another receiver device other than itself, then the device may just ignore the received frame and continue checking until OTA medium has reached the end of busy (becoming idle again).

In another example, a device wishing to transmit may listen for the OTA medium for a time interval. If the OTA medium is idle for the duration of the time interval, it means that no other device is transmitting, and thus, the device may be permitted to transmit at the end of the time interval. In some embodiments, the time interval may be SIFS plus a number of slot time intervals (slotTime). For example, in some 802.11 protocols, the time interval may be AIFS (arbitration interframe space), which may be AIFSN×slotTime+SIFS, where AIFSN is an arbitration interframe space number.

In some protocols that support Enhanced Distributed Channel Access (EDCA), AIFSN may be a number associated with an access category (AC), which may correspond to a user priority (UP) associated with the data units to be transmitted. In non-limiting examples, for transmitting data units with higher UP, AC may be associated with a more urgent category (e.g., for voice) and a smaller value may be used for AIFSN, thus the time interval for checking the OTA medium may decrease. In contrast, for transmitting data units with lower UP, AC may be associated with a less urgent category (e.g., best effort) and a larger value may be used for AIFSN, thus the time interval for checking the OTA medium may increase. In some examples, the time interval may be adjusted by a random number. In some examples, the shortest AIFS may be SIFS+2×slotTime (when AIFSN=2, and the random number happens to be zero).

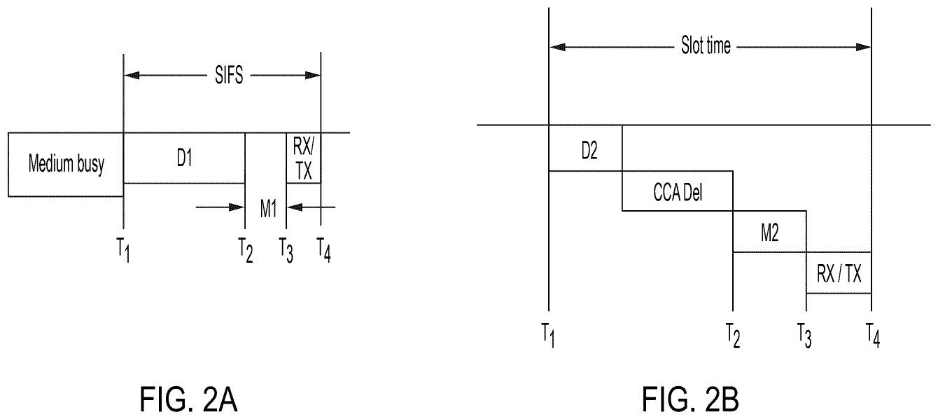

The inventors have recognized and appreciated that the MAC of a device, which is mostly responsible to determining whether the device is permitted to transmit (e.g., based on conditions as described above and further herein), may have very little time to make the decision due to timing constraint. For example, for sending an IR at the end of SIFS following the OTA medium becoming idle, the MAC will have only a fraction of the SIFS interval to make the determination due to the PHY layer delay in receiving the frame. Similarly, if the OTA medium is idle for the AIFS duration, a device wishing to transmit will not know that the condition for transmission is met until very late in the AIFS interval due to the PHY layer delay, causing the MAC to have little time to make the decision to transmit before the end of AIFS interval. The PHY layer delay and timing restraint for the MAC are further illustrated with reference to FIGS. 2A-2B.

FIG. 2A is a timing diagram showing the PHY layer delay in SIFS interval, according to some embodiments. As described above and further herein, the OTA medium may be busy and a device may be in a receiving mode. The device may receive a frame that may or may not be intended for that device. As shown in FIG. 2A, at time T₁, the last symbol of a frame was transmitted in the OTA medium. This symbol would not be received by the MAC layer instantly until a delayed time at T₂, where the delay D1 (e.g., T₂−T₁) is caused by the PHY delay, such as the transceiver(s), RF modules, baseband modules in the device. At time T₂, the MAC would have received all the information needed to determine whether the device is the intended receiver device and needs to transmit a response. For example, upon receiving the complete frame, the MAC may determine that a valid frame is received, decode the frame and determine whether to send a response. If the MAC has determined to send a response, the MAC will need to send the response at the end of the SIFS interval, at time T₄.

As shown in FIG. 2A, to transmit a response at time T₄, the MAC needs to account for a hardware delay RxTx (e.g., T₄−T₃), which is associated with a transmission start delay, e.g., a turnaround time for the device to switch from a receiving mode to a transmitting mode. This leaves the processing time M1 for the MAC to make the determination about the transmission to be a fraction of the SIFS interval. In the example as shown, M1 would be the duration of SIFS subtracting the delay D1 and RxTx delay. In a non-limiting example, SIFS may be 16 μs, D1 may be 12 μs, RxTx delay may be 2 μs. As a result, the MAC processing time M1 may be as little as 2 μs.

FIG. 2B is a timing diagram showing the physical layer delay in slot time interval, according to some embodiments. As described above and further herein, a device wishing to transmit may listen for the OTA medium and wait for the OTA medium to be idle for a AIFS duration (e.g., SIFS+2*slotTime). If the OTA medium is idle for the duration of AIFS, it means that no other device is transmitting, and thus, the device may be permitted to transmit at the end of the AIFS duration. Assuming the slot time shown in FIG. 2B is the last slot time in the AIFS. Upon determining that this last slot time is idle, the MAC will make decision to transmit at the end of the slot time. FIG. 2B shows hardware delay, e.g. time T₂−T₁. This delay may be caused by the air propagation time and time it takes for the receiver to determine if the OTA medium is busy or not (D2+CCADel time). At time T₂, the MAC will have determined that the current slot time is idle (thus the OTA medium is idle for the entire duration of AIFS) and therefore will prepare to transmit. Similar to what is shown in FIG. 2A, the MAC needs to account for a hardware delay RxTx (e.g., T₄−T₃), which is associated with a transmission start delay, e.g., a turnaround time for the device to switch from a receiving mode to a transmitting mode. This leaves the processing time M2 for the MAC to make the determination about the transmission to be a fraction of the slot time interval. In the example as shown, M2 would be the duration of the slot time subtracting the delay D2+CCADel (T₂−T₁) and RxTx delay. In a non-limiting example, slot time may have an interval of 9 μs, the air propagation time and CCA detection time together (D2+CCADel) may be 4 μs, RxTx delay may be 2 μs. As a result, the MAC processing time M2 may be as little as 3 μs.

As shown in FIGS. 2A and 2B, in a wireless communication network, the MAC of a device may be required to process information and make determination quickly mainly due to the PHY layer delay and a turnaround time for the hardware (e.g., transceiver) to switch from receiving to transmitting. To meet this requirement, existing systems put more computing power for the MAC layer, e.g., using higher performance hardware. Other systems attempt to reduce the hardware/PHY layer delay, leaving rooms for the MAC processing time.

The inventors have recognized and acknowledged that existing systems may require more computing power from the hardware (e.g., circuitry) and thus, increase the cost of the device. Further, the evolving wireless standard may even impose more challenges on the MAC processing time (e.g., M1, M2 as shown in FIGS. 2A and 2B) due to higher constraint on the hardware for higher throughput. For example, the next standard WiFi-7 may result in even a longer PHY layer delay and reduced processing time is inevitable for the MAC. As the standard is evolving, this challenge on the MAC processing time may even be more evident. Given the nature of collision in the wireless communication network, if a MAC cannot finish the computations within the available processing time (e.g., M1, M2), the device may fail to send a response or start transmitting at an allowed time, resulting in missing the transmission opportunity and thus, negatively affecting the performance of the device or the wireless communication network.

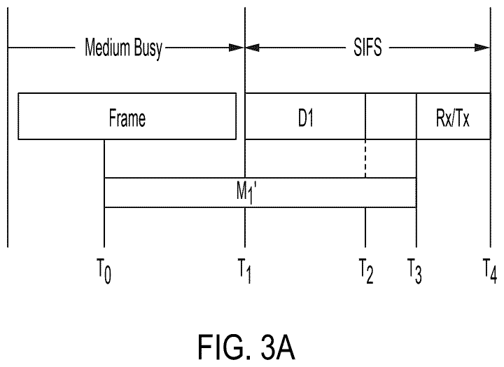

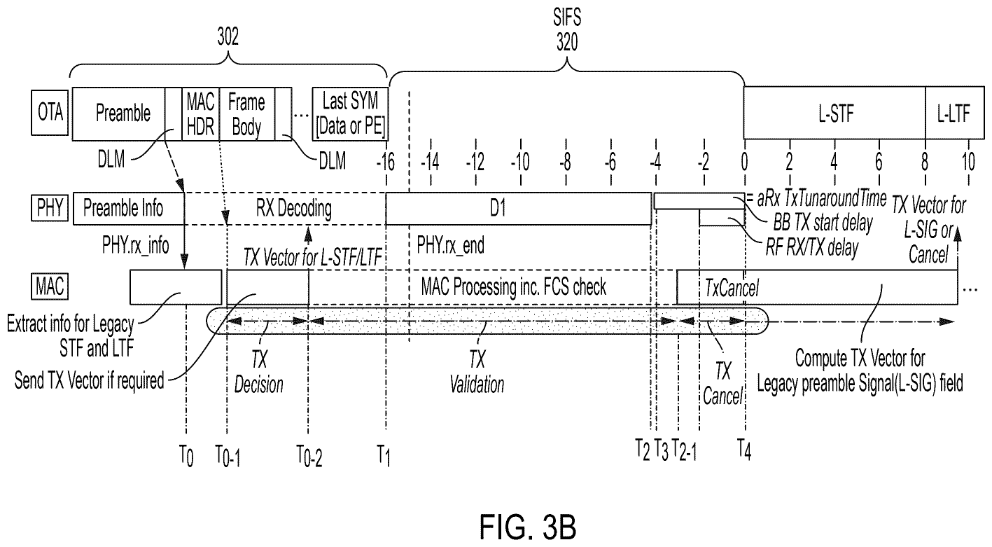

Accordingly, the inventors have developed techniques for relaxing the processing time requirement for the MAC, in particular, by reducing the timing dependency between the physical layer delay and the MAC. Details of these techniques are further described in FIGS. 3A-4 and 5A-6.

FIG. 3A is a timing diagram showing optimized timing relationship between the MAC and PHY layers, where a response is prepared in the MAC layer before receiving the last symbol in a frame, according to some embodiments. FIG. 3A may be applicable to a scenario shown in FIG. 2A, where a device may transmit an IR following receiving a frame. In some embodiments, a device may be receiving a frame while the OTA medium is busy (before time T₁). The device may start the MAC processing before receiving the last symbol in the frame, e.g., at time T₂. For example, the MAC processing may start before the beginning of the SIFS interval. As shown in FIG. 3A, in some embodiments, the MAC processing may start when at least a partial frame is received, e.g., at time T₀. In comparison to FIG. 2A, the processing time available for the MAC is M1′, which starts before the MAC receives the last symbol in the frame, e.g., T₀. This makes M1′ longer than M1 as discussed in FIG. 2A, thus effectively relaxes the timing requirement and reduces the processing burden for the MAC layer.

FIG. 3B shows detailed implementation of the timing diagram shown in FIG. 3A, according to some embodiments. As shown, the MAC of a device may be in a receiving mode and is receiving a frame 302 while the OTA medium is busy. A frame being transmitted/received in the OTA medium may include multiple fields, such as a preamble, one or more data units, e.g., MPDUs (an MPDU may include a MAC header plus frame body) with optional delimiter (DLM). These fields, in some embodiments, are described in the 802.11 specification. In some examples, the preamble field may be stored in a data structure, e.g., PHY Preamble_INFO primitive which may be accessible to the MAC layer. In some embodiments, the MAC processing may include receiving these fields sequentially, and processing these fields as they are received, instead of processing altogether after receiving the last symbol in the frame.

In some embodiments, the MAC may first receive a first portion of a frame, and determine whether one or more conditions for transmitting a response are met, before receiving the last symbol of the frame. As shown in FIG. 3B, the MAC may start processing as early as when partial information in the frame 302 is received. For example, after preamble of the frame is received at time T₀, the MAC may start processing. The processing may include preparing an immediate response, e.g., an IR, as if the frame being received were intended for the device itself and requires IR.

In some embodiments, a response to be transmitted may include information containing training symbols. For example, the training symbols may include a short legacy field (L-STF) followed by a long legacy field (L-LTF). In some examples, the MAC may use the preamble information at least in part to prepare information for transmitting legacy short and long training fields (e.g., L-STF, followed by L-LTF). In non-limiting examples, the received preamble of a frame may include information about PPDU (physical layer protocol data unit) type, which may be required for transmitting the preamble for L-STF and L-LTF. It is appreciated that other information may be extracted from the received preamble and used in transmitting the preamble for training symbols.

In some examples, the MAC may check whether one or more additional conditions for transmitting a response are met before receiving the last symbol. In response to determining that the one or more conditions are met, the MAC may pre-configure the PHY layer to transmit a response along with the information for the response. For example, if IR is required to be transmitted, the MAC may send transmission information (e.g., in a transmission (Tx) vector) for the training symbols to the PHY layer, and the PHY may transmit the response via the OTA at the ending edge of SIFS interval 320. This is further explained with reference to FIG. 3B.

As previously discussed and further herein, a frame to be received by a target receiver device may be broadcasted in the wireless network to all devices. A receiving device for the frame may check one or more MAC header fields in the frame to determine whether the frame being received is intended for the receiving device itself. For example, at time T₀₋₁, after receiving the MAC header field(s) in the frame 302, the MAC may check the MAC header(s) to determine whether the targeted receiver device (e.g., as indicated by the MAC header(s)) is the device itself (e.g., as compared against the device's own MAC address). If the frame is targeted for the device itself (e.g., the MAC address in a MAC header field in the frame matches the MAC address of the device itself), the MAC processing may continue; otherwise, the MAC may ignore the frame and stop processing. In the latter case, the MAC may continue checking the OTA medium until it is idle.

With further reference to FIG. 3B, at time T₀₋₁, the MAC determines based on the MAC header(s) that the target receiver device is the device itself, the MAC may prepare information for an IR to the frame. For example, the MAC header field(s) may indicate a RTS frame. In response, the MAC may prepare a CTS signal in the IR. In other examples, the MAC header field(s) may indicate data in the frame. In response, the MAC may prepare an ACK (acknowledgment) or a BA (block acknowledgment) for aggregated MPDUs. Additionally, and/or alternatively, the MAC may prepare other transmission information, based on checking frame control field of the frame (FCF, indicating which frame is being received and what frame type is required for IR), in some embodiments. The MAC may subsequently transmit the transmission information for the training symbols to the PHY (e.g., preparing a Tx vector containing the transmission information), at time T₀₋₂, to prepare the hardware for transmission.

If an IR is required, the MAC may send a transmission command (Tx_Start signal) to the PHY, if the OTA medium is idle between T₂ (after receiving the last symbol of the frame) and T₃ (a lead time in advance of the end of SIFS interval by a transmission start delay), as shown in FIG. 3B, where T₃−T₂ may correspond to M1 (FIG. 2A). The PHY may be configured to transmit the response at a scheduled time according to a given wireless protocol, e.g., at the end of a SIFS interval as shown at time T₄. The response may be transmitted to the OTA medium following any suitable protocol. For example, following time T₄, the PHY may send L-STF, followed by L-LTF to train the receiver, followed by sending a signal field (L-SIG) that contains signaling.

In some embodiments, the MAC may perform transmission validation. Transmission validation may refer to a process for determining whether a transmission of a response that is already prepared should happen (when validation succeeds) or cancel (when validation fails). If the transmission validation fails, the validation process may decide to cancel the transmission. For example, the MAC may reset or configure the hardware of the PHY to disregard the transmission information previously sent (e.g., via Tx vector at time T₂₋₁). In some examples, the MAC may cancel the transmission command (e.g., Tx_Start) that is already sent to the PHY between time T₂ and T₃. In some embodiments, canceling transmission may be performed up to before the signal field (e.g., L-SIG) is transmitted to OTA medium.

As shown in FIG. 3B, the transmission validation period may begin after making the transmission decision, e.g., at time T₀₋₂. Transmission validation process may be carried throughout the time when the remaining of data units, e.g., MPDUs in frame 302 are received until after the last symbol of the frame is received, e.g., at time T₂. In some embodiments, if the validation succeeds, the device may proceed with transmitting the IR based on the transmission information previously prepared.

In some embodiments, transmission validation may be performed based on other fields subsequently received in the frame. For example, if the fields subsequently received indicate that the frame is invalid, for example, due to failure of error correction checking, the transmission validation may fail. In non-limiting examples, a frame may include a single frame body, e.g., MPDU, where the MPDU may have a FCS (frame check sequence), which is an error detecting code added to the frame and can be used for error checking. For example, the FCS may be a checksum for the MAC header and frame body. In some embodiments, FCS may be the last symbol of the frame body for the frame with one MPDU. Upon receiving the FCS code, the receiver device may use FCS to perform error checking to determine whether the received MPDU is error-free.

In other non-limiting examples, a frame may include multiple MPDUs (aggregated MPDU), where each of the MPDUs may have its respective FCS such as described with respect to the single MPDU. In such case, each of the MPDUs may be checked for error based on its own respective FCS code. Thus, as each MPDU is received by the MAC, the MAC may determine if any MPDU is error-free (and thus prepare ACK or BA in the response), without waiting for the last MPDU to be received. As shown in FIG. 3B, the transmission validation process is ongoing while one or more MPDUs in the frame (e.g., 302) are received by the MAC. This process lasts until receipt of the last symbol of the last frame body of the frame 302, such as at time T₂ (considering the PHY delay for receiving the frame), at which time the MAC may send an acknowledge signal, e.g., ACK or block acknowledgment (BA) IR frame, to acknowledge successfully received (e.g., error-free) MPDUs in the frame to the device which sent the frame.

In some embodiments, transmission validation may make the decision as to whether to transmit the response, for which information about the response is sent to the PHY, e.g., at time T₀₋₂. The validation decision period may start from, e.g., T₀₋₂, through T₂₋₁ (considering the time for the MAC to process the last frame body from the time the last frame body is received at T₂). The MAC may implement any suitable validation policy. For example, in a single MPDU scenario, the MAC may determine to validate a transmission once the MPDU is checked to be error-free. In aggregated MPDU (AMPDU) scenarios, the MAC may determine to validate a transmission (validation is passed) as soon as at least one MPDU is checked to be error-free. In other words, not all MPDUs in aggregated MPDU need to be error free before requiring a receiver device to send a BA. In other policies, in a single MPDU scenario, the validation may be passed after the last frame body is received error-free, e.g., at T₂. In such case, the latest time for validation decision may be at T₂₋₁, considering the time for the MAC to process the last frame body from the time the last frame body is received at T₂.

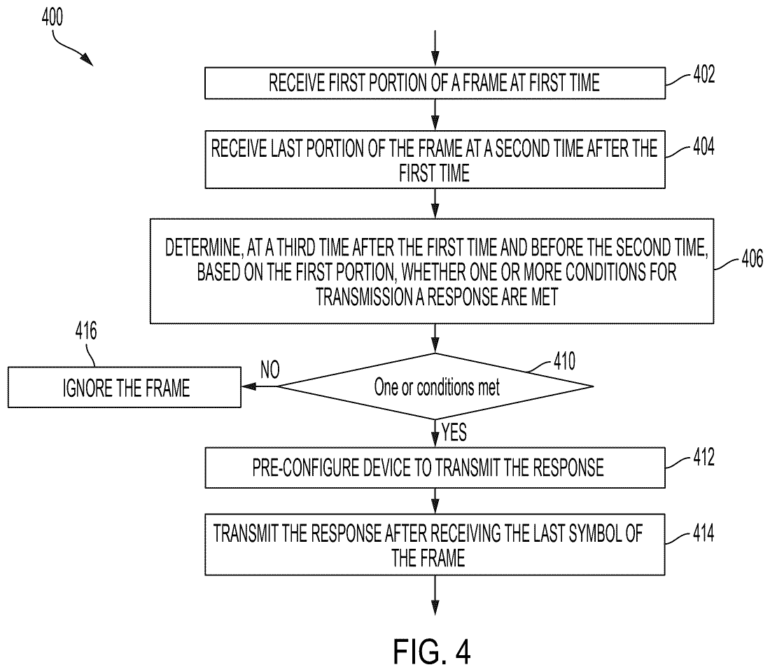

Having described the reduction of timing dependency of the MAC processing on the PHY delay, details of a method 400 for communicating packets in a wireless communication network are further described. FIG. 4 is a flow diagram of an example process for implementing at least in part the timing diagrams shown in FIG. 3B, according to some embodiments. The method may be implemented in the MAC layer of a device (e.g., any of client or AP as shown in FIG. 1), for example.

In non-limiting embodiments, method 400 may receive a first portion of a frame from the OTA medium at a first time, at act 402, and receive a last portion of the frame at a second time after the first time, at act 404. For example, similar to embodiments in FIG. 3B, the first portion may include a preamble of the frame, and/or additionally the MAC header(s) of one or more MPDUs in the frame. The last portion of the frame may include the last MPDU in the frame, or the last field (e.g., FCS) in the last MPDU in the frame, in some examples. In non-limiting examples, the first time may be time T₀ when the MAC receives the preamble of the frame (e.g., frame 302 in FIG. 3B) and the second time may be time T₂ as shown in FIG. 3B.

Method 400 may further include determining, at a third time after the first time and before the second time, based at least in part on the first portion of the frame, whether one or more conditions for transmitting a response are met, at act 406. For example, in a similar manner as described in FIG. 3B, method 400 may determine information for transmitting the training symbols in a response (e.g., IR) as if the intended receiver device of the frame were the device. Additionally, and/or alternatively, the method may check one or more MAC header(s) of the received frame to determine whether the device itself is the intended receiver device of the frame, and/or an IR response is required, in a similar as described in FIG. 3B.

In some embodiments, checking the MAC header may include comparing the MAC address in the MAC header with the MAC address of the device. Based on the comparison, the method may determine whether the intended receiver device of the frame is the device itself. If it is determined that the intended receiver device of the frame is not the device itself, the received frame may be intended for another device, and thus, the one or more conditions for transmitting a response are not met. If it is determined that the intended receiver device of the frame is device itself and an immediate response is required, the one or more conditions for transmitting a response are met.

In response to determining that one or more conditions are met (at act 410), method 400 may proceed to act 412 to pre-configure the device to transmit the information for the response before the second time; and transmit the response to the OTA medium after receiving the last portion of the frame, at act 414. In some examples, act 414 may be performed when the one or more conditions are met and transmission validation (as described above and further herein) is passed. In response to determining that one or more conditions are not met (at act 410), method 400 may ignore the frame at act 416.

Act 412 of pre-configuring the device to transmit the response may involve sending information for transmission to the PHY layer to configure one or more transceivers (e.g., transceivers shown in FIG. 1) to be ready for transmission. For example, a transmission vector containing information for training symbols in a frame may be provided to the PHY layer for preconfiguring the device for transmission. As shown in FIG. 3B, pre-configuring the device may be performed before the MAC receives the last symbol of the frame, e.g., before time T₂. Then, method 400 may transmit the response to the OTA medium (e.g., sending a Tx_Signal command) after receiving a last symbol of the frame, e.g., after time T₂. Then, the PHY may transmit the IR at the end of SIFS interval, e.g., at time T₄.

In some embodiments, before transmitting the IR at the end of SIFS interval, the method may include a transmission validation process, such as described above and further herein. In some embodiments, the MAC processing may include receiving one or more data units, e.g., MPDUs of the frame from the OTA medium at a time after receiving the MAC header. For example, subsequent to preparing information for the IR at T₀₋₂, the transmission validation may be performed based on one or more MPDUs received, as described in embodiments in FIG. 3B.

With further reference to FIG. 4, based on the outcome of transmission validation, e.g., the validation is passed, method 400 may determine to transmit the response to the OTA medium at the next time, e.g., at the end of the SIFS interval following receiving the last symbol of the frame (see FIG. 3B). For example, the MAC may let the PHY transmit the response (already prepared at act 406) to the OTA medium, e.g., at act 414 (FIG. 4) at T₄ (FIG. 3B). In some embodiments, the method may determine not to transmit the response, for example, due to failure of transmission validation, even the response was already generated at act 406. In such case, the method may send a command to the PHY layer to cancel the transmission pre-configuration performed at act 412, e.g., at time T₂₋₁ (see FIG. 3B). As shown in FIG. 3B, transmission cancellation may occur between T₂₋₁ to T₄. In some examples, the transmission cancellation may occur before transmitting L-SIG in a response frame (even this may occur after time T₄).

The techniques described in FIGS. 3A-3B and 4 provide advantages over existing devices. For example, comparing FIGS. 3A-3B with FIG. 2A, the MAC processing time for making determination for a response is more relaxed (comparing M1 shown in FIG. 2A to M1′ shown in FIG. 3A, or duration of T₀₋₁ to T₂₋₁ in FIG. 3B). Although the timing between the receipt of the last symbol of the frame (e.g., T₂) and the lastest time to send the response (e.g., T₃) is still short, the MAC has already started processing at an earlier time, such as before receiving the last symbol of the frame, which allows the MAC to process information incrementally while receiving more information in the frame, and make final decision as the last symbol in the frame is received.

Considering aggregated MPDU as supported by some 802.11 protocols, a frame may include aggregated MPDUs, e.g., 64 MPDUs, 256 MPDUs, or even over 1,000 MPDUs (e.g., Wi-Fi 7). In these scenarios, validation checking may be performed block by block for each MPDU as they are received, instead of waiting for the last block to be received. As shown in FIG. 3B, the time T₃−T₂, which corresponds to M1 (FIG. 2A) only requires the MAC to process the last symbol of the received frame (e.g., 302 in FIG. 3B) rather than the entire frame, where the time required to process the last symbol in the frame may be a short interval. The relaxation of the timing relationship between the MAC processing time and the PHY delay results in less computing power required for the MAC processing during a short time, and thus, lower hardware requirement (e.g., the speed of the MAC processor) and/or power saving of the MAC chip(s). Further, the techniques provided herein would result in guaranteed IR being sent within the permitted timeframe, e.g., SIFS, reducing the probability of missing the permitted timeframe and thus, losing the proper Frame Exchange Sequence (FES) in the wireless communication.

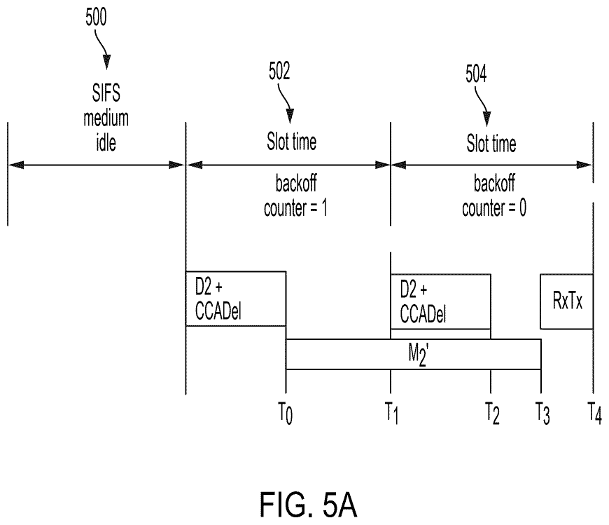

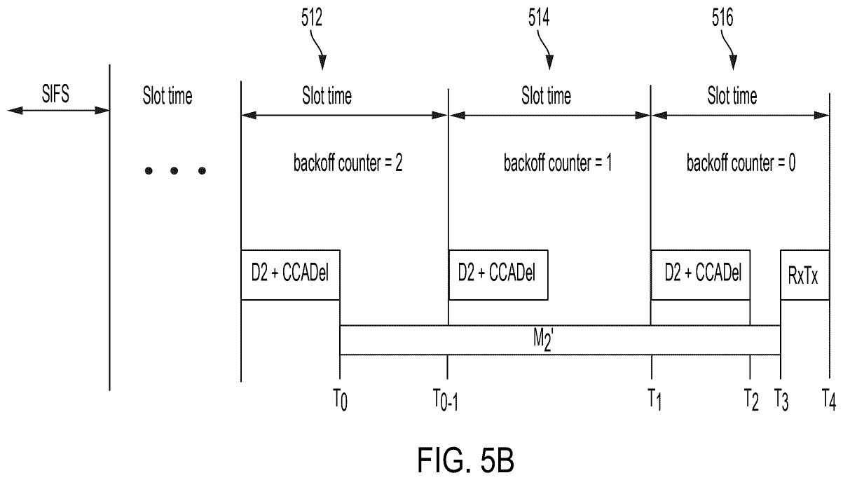

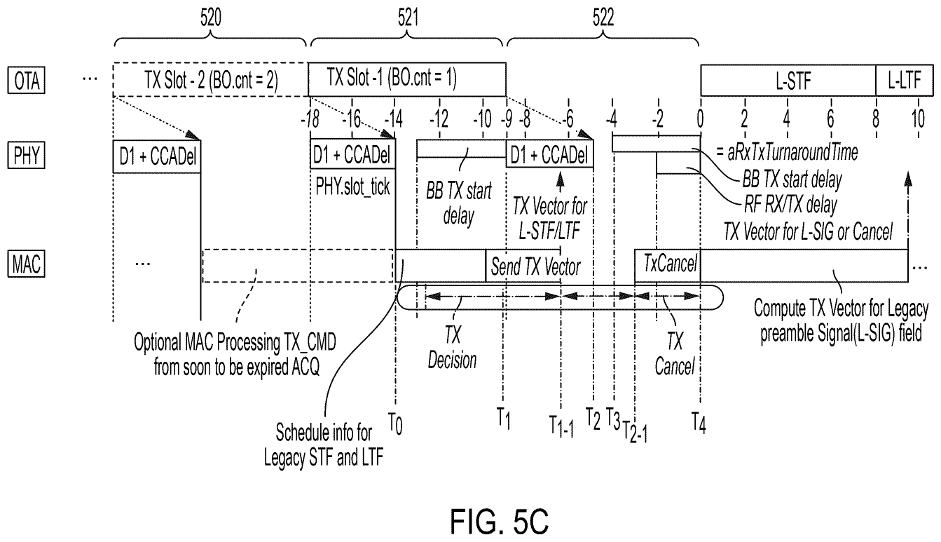

FIGS. 5A and 5B are timing diagrams showing optimized timing relationship between the MAC and PHY layers, according to various embodiments. FIG. 5A may be applicable to a scenario shown in FIG. 2B, where a device contending for OTA medium may wait for a SIFS+2*slotTime interval before transmitting a response. FIG. 5B shows a scenario in which a device may need to wait for more than two slot time intervals after checking the OTA medium for idle in the initial SIFS interval. In FIGS. 5A and 5B, the MAC may check whether the OTA medium is busy/idle for an initial SIFS interval. Once the OTA medium is idle for at least an SIFS interval, the MAC may assume no device is sending anything, and then start counting the initial wait time plus random time period (set backoff counter). In some embodiments, the wait time (backoff counter) may be different for different devices. For example, as describe previously and further herein, when the wireless protocol supports EDCA, the backoff counter for a device may be set depending on the AIFSN and random time period.

In some embodiments, the MAC may check subsequent number of slot time intervals depending on the backoff counter. If OTA medium continues being idle for a subsequent slot time interval, then the MAC may decrement the backoff counter and wait for another slot time interval until the backoff counter expired (or reaching the last slot time). During the wait time, if another device starts sending, the medium will be busy again, and all the processes will start over and the cycle goes back to SIFS as before. When the backoff counter expires (the last slot time is reached), the device may be permitted with transmission opportunity (TXOP) to transmit OTA at the end of the last slot time interval.

In a non-limiting example in FIG. 5A, after the SIFS interval 500 is passed (while the OTA medium is idle), the backoff counter may be set to 1, which means the device may need to wait for one slot time intervals for the medium to be idle. If the OTA medium is idle in the first slot time 502, the MAC may decrement the backoff counter by one, from 1 to 0, to check the last slot time 504 (where zero backoff counter means the backoff time expired). If the OTA medium is idle in the last slot time, the device is permitted to transmit at the end of the last slot time, e.g., slot time 504, at time T₄.

As shown in FIG. 5A, the MAC processing time for transmission (to be performed at the end of the last slot time) may start early in a preceding slot time (e.g., 502) instead of waiting for the determination in the last slot time as to whether the OTA medium is busy or idle during the last slot time. For example, the MAC processing may start in the slot time 502, at time T₀, preceding the last slot time. Time T₀ may be the time when the MAC has determined whether the OTA medium for that slot time is idle. The time period from the beginning of the slot time 502 to time T₀ indicates a PHY delay (e.g., D2+CCADel as shown in FIG. 2B) needed for the MAC to check the OTA medium busy/idle. The MAC processing may continue until determining whether the OTA medium is busy in the next (last) slot time 504, at T₂, where T₂, similar to T₀, indicates a PHY delay from the start of that slot time (e.g., slot 504). If the device determines to transmit following checking the OTA medium being idle for the last slot time, the device may transmit at the end of the last slot time, e.g., at time T₄. For example, between T₂ and T₃ (a lead time in advance of the end of time slot T₄ by a transmission start delay), the MAC may determine that the OTA medium is idle, then send a transmission start command to the PHY during this time (between T₂ and T₃), followed by the PHY transmitting at time T₄. In comparison to FIG. 2B, the processing time for the MAC is M2′, which started in a slot time preceding the last slot time (before the backoff counter expires). This makes M2′ longer than the M2 as discussed in FIG. 2B, thus effectively relaxing the timing requirement and reducing the processing burden for the MAC.

In FIG. 5B, a device may need to check the OTA medium for idle for more than two slot time intervals. In this example, the MAC processing may start in slot time 512, at time T₀, two slot time intervals before the last slot time 516. Similar to FIG. 5A, time T₀ may be a delayed time from the beginning of the current slot time indicating a PHY delay (e.g., D2+CCADel as shown in FIG. 2B) needed for checking the OTA medium busy/idle. Although it is shown in FIG. 5B that the MAC processing may start two slot time intervals before the last slot time, it is appreciated that the MAC may start processing in any suitable slot time intervals before the last slot time (when the backoff counter expired).

As shown in FIG. 5B, following slot time 512, the MAC may continue checking whether the OTA medium is idle in subsequent slot times, each time decrementing the backoff counter until the backoff counter is expired (e.g., value 0), which is the last slot time 516. If the OTA medium is busy during any of the subsequent slot times, it means that another device is occupying the OTA medium, and thus the MAC may back off and restart the cycle (with the backoff counter reset to a new randomized value). If the MAC determines, following checking the OTA medium being idle for the last slot time 516, that the device may be permitted TXOP, the MAC may transmit OTA at the end of the last slot time, e.g., at time T₄. In comparison to FIG. 5A, the MAC processing may start from time T₀ and continue through the last slot time, at time T₂, allowing even a longer processing time for the MAC.

FIG. 5C shows detailed implementation of a timing diagram that may apply to FIGS. 5A and 5B, according to some embodiments. In some embodiments, the MAC of a device may have checked the OTA medium being idle for in an initial SIFS interval. Subsequently, the MAC will check for OTA medium being idle for a required number of slot times measured by a backoff counter, until the backoff counter expired (becomes zero). In a non-limiting example in FIG. 5C, the MAC starts processing in slot time 521 (the slot time preceding the last slot time) and the backoff counter is 1. It is appreciated that the MAC can start processing in any other suitable slot times before the last slot time (such as what is shown in FIG. 5B). As described above and further herein, if the OTA medium is busy in slot time 521, the MAC may start over from SIFS as previously described, including checking the OTA medium for busy/idle for an initial SIFS interval again and resetting the backoff counter.

In slot time 521, the MAC may start processing as early as it has determined that the OTA medium is idle, e.g., at time T₀. The MAC may prepare the information for transmission as if subsequent slot times through the last slot time were also idle, in which case, the MAC will be permitted TXOP time (e.g., 2.528 ms or any other suitable time) to transmit at the end of the last slot time.

To transmit during TXOP time, the PHY layer of a device may be provided various information for transmission. For example, a device may initiate the transmission for the preamble generation, e.g., RTS (request to send) to be sent to a receiver device. Thus, the MAC may determine information to be used for generating preamble for RTS. For example, in a similar manner as described in embodiments in FIG. 3B, the MAC may generate transmission information information sending L-STF and L-LTF. For example, the transmission information may include schedule information for L-STF and L-LTF. The MAC may subsequently transmit the transmission information to the PHY, at time T₁₋₁, to prepare the hardware for transmission. In some embodiments, the PHY may transmit to the OTA medium at a scheduled time according to a given wireless protocol, e.g., at the end of the last slot time 522, e.g., at time T₄. Transmission may be performed following any suitable protocol. For example, following time T₄, the MAC may send legacy short and long training frames (e.g., short legacy frames L-STF, followed by long legacy frames L-LTF) to train the receiver, following by L-SIG (signaling).

In some embodiments, the MAC may perform transmission validation in a similar manner as described in FIG. 3B. As shown in FIG. 5B, transmission information may be sent to the PHY any time before T₃ (due to the baseband transmission start delay), where T₃−T₂ corresponds to M2 (FIG. 2B). Transmission validation may start once the information for transmission is prepared and sent to the PHY, e.g., at time T₁₋₁. Transmission validation may include continuing checking whether the OTA medium is idle in subsequent slot time intervals through the last slot time. If, at any subsequent slot time, the OTA medium is busy, or the condition of OTA medium idle does meet certain transmission requirement (e.g., stored in a transmission vector), the validation may fail. In such case, the transmission command that is already sent to the hardware at time T₁₋₁ needs to be canceled. In canceling transmission, the MAC may send a transmission cancellation command to the PHY, e.g., at time T₂₋₁. Transmission cancellation may occur before from T₂₋₁ to T₄, where T₂₋₁−T₂ is the delay from T₂ for processing the OTA medium status (e.g., busy/idle), and T₄ is the end of the last slot time, e.g., 522.

The transmission validation process may continue until checking the OTA medium for busy/idle in the last slot time, e.g., slot time 522. Only until that time may the MAC determine whether the transmission validation succeeds (when the OTA medium is idle for the entire wait time). If the transmission validation succeeds, it will be determined that the condition for TXOP is met, and thus, the device will transmit frame(s) based on the transmission information (previously prepared) at the end of the last slot time.

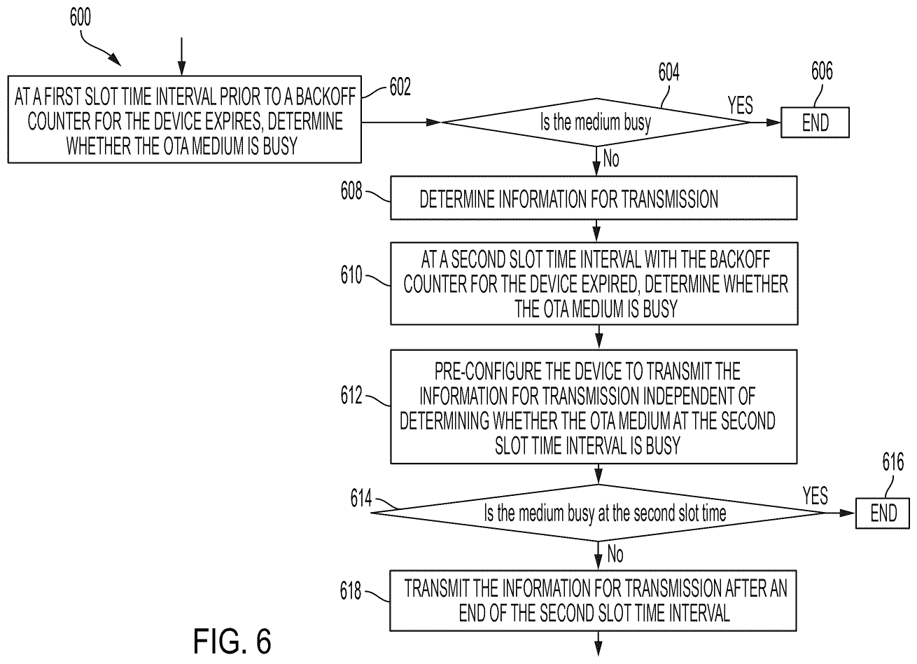

Having described the reduction of timing dependency of the MAC processing on the PHY delay, details of a method for communicating packets in a wireless communication network are further described. FIG. 6 is a flow diagram of an example process 600 for implementing at least in part the timing diagrams shown in FIGS. 5A-5C, according to some embodiments. The method may be implemented in the MAC layer of a device (e.g., any of client or AP as shown in FIG. 1), for example. In non-limiting embodiments, method 600 may, at a first slot time interval prior to a backoff counter for the device expiring, determine whether the OTA medium is busy, at act 602. For example, at time T₀ in slot time 521 (FIG. 5C), the MAC may detect whether the OTA medium is busy, where T₀ indicates a PHY delay from the beginning of the current slot time, such as D2+CCADel, as described in FIG. 2B. In this configuration, the MAC does not need to wait for the last slot time to be idle to prepare the information for transmission.

If it is to determined that the OTA medium at the first slot time interval is busy at act 604, it indicates that at least another device is occupying the medium, and thus, method 600 may ignore the slot time and start over, at act 606. In response to determining that the OTA medium at the first slot time interval is not busy at act 604, method 600 may proceed to act 608 to determine information for transmission. In non-limiting examples, information for transmission or other transmission information may be determined based on one or more paramters such as described in embodiments in FIG. 5C.

Following act 604, if it is determined that the OTA medium at the first slot time interval is not busy, method 600 may further include, at a second slot time interval with the backoff counter for the device expired, determining whether the OTA medium at the second slot time interval is busy, at act 610. For example, the MAC may check whether the medium at slot time 522 (the last slot time) is busy, at time T₂ (see FIG. 5C). Independent of act 610, method 600 may pre-configure the device to transmit the information for transmission, at act 612. For example, the MAC may pre-configure the PHY to prepare transmission at a time before determining whether the medium is busy at the last slot time. In the example in FIG. 5C, the MAC may pre-configure the device, at time T₁₋₁, by sending the information for transmission to the PHY. In some examples, the transmission information may include schedule information for L-STF and L-LTF to be transmitted.

Following act 610, if it is determined that the OTA medium at the second slot time (e.g., slot time 522) is idle, at act 614, method 600 may proceed to act 618 to transmit to the medium after an end of the second slot time interval, such as time T₄ (FIG. 5C), when the TXOP is available. Otherwise, method 600 may ignore the slot time and start over, at act 616.

In some embodiments, before transmitting at the end of the last slot time interval, the method may include a transmission validation process, such as described above and further herein. In some embodiments, the MAC processing may determine whether the OTA medium at the last slot time is busy. For example, the MAC may make that determination at time T₂ (shown in FIG. 5C) in the last time slot 522. Based on the outcome of the determination, the method may determine whether to cancel the transmission. For example, in response to determining that the second slot time interval is busy, the MAC may decide to cancel the transmission to the OTA medium scheduled for the end of the second slot time interval. Similar to embodiments in FIGS. 3B and 4,

In some embodiments, the method may determine not to transmit the response, for example, due to failure of transmission validation, even the response was already generated at act 612. In such case, the method may send a command to the PHY layer to cancel the transmission pre-configuration performed at act 618, e.g., at time T₂₋₁ (see FIG. 3B). As shown in FIG. 5C, transmission cancellation may occur from T₂₋₁ to T₄.

It is appreciated that method 600 may also apply to timing diagrams in FIG. 5B, for which the MAC may need to wait for more than SIFS+2*slotTime. For example, the first slot time and the second slot time may be adjacent (as in FIG. 5A), or separated by at least one slot time (as in FIG. 5B). In other variations, canceling transmission may occur anytime the transmission validation fails, without waiting for the last slot time.

The techniques described in FIGS. 5A-5C and 6 provide advantages over existing systems. For example, comparing FIGS. 5A-5C with FIG. 2B, the MAC processing time for making a determination of whether/what to transmit is more relaxed (comparing M2 shown in FIG. 2B to M2′ shown in FIGS. 5A and 5B, or duration of T₀ to T₂₋₁ in FIG. 5C). Although the timing between determining the OTA medium busy/idle for the last slot time (e.g., T₂) and the lastest time to determine whether to transmit (e.g., T₃) is still short, where T₃−T₂ corresponds to M2 (FIG. 2B), the MAC has already started processing at an earlier time, such as before the last slot time interval, which allows the MAC more time to prepare information for transmission while waiting for the OTA medium to be idle for a specified time period in a given protocol.

As discussed above, it is appreciated that the techniques shown in FIGS. 5A-5C and 6 may be applicable to any suitable backoff counter mechanisms, such as EDCA, which is used in certain 802.11 protocols. In some embodiments, the MAC processing may start early in the slot time preceding the last slot time (see FIG. 5A) or any other slot time before the last slot time (see FIG. 5B). The relaxation of the timing relationship between the MAC processing time and the PHY delay results in less computing power required for the MAC processing during a short time, and thus, lower hardware requirement (e.g., the speed of the MAC processor) and/or power saving of the MAC chip(s). Further, the techniques provided herein would guarantee a transmission be ready when the TXOP is available, reducing the probability of a device losing a transmission opportunity, thus improving the performance of the wireless communication network.

The various methods or processes outlined herein may be implemented in hardware, e.g., one or more ICs, or coded as software that is executable on one or more processors that employ any one of a variety of operating systems or platforms. For example, any part of the methods described above may be implemented in hardware, software, or in combination. Additionally, such software may be written using any of numerous suitable programming languages and/or programming or scripting tools, and also may be compiled as executable machine language code.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. A method for communicating packets in a wireless communication network, the method comprising, at a device:
receiving a first portion of a frame from an over the air (OTA) medium at a first time;
receiving a last portion of the frame from the OTA medium at a second time after the first time;
determining, at a third time after the first time and before the second time, based at least in part on the first portion of the frame, whether one or more conditions for transmitting a response are met; and
in response to determining that the one or more conditions for transmitting a response are met:
pre-configuring the device to transmit the response before the second time; and
transmitting the response to the OTA medium after the second time;
otherwise:
ignoring the frame.

2. The method of claim 1, wherein transmitting the response to the OTA medium is performed additionally in advance of an end of a frame space in which the last portion of the frame was received by at least a turnaround time required for the device to switch from a receiving mode to a transmitting mode.

3. The method of claim 1, further comprising:
receiving one or more media access control (MAC) protocol data unit (MPDUs) of the frame from the OTA medium at or before the second time, the one or more MPDUs comprising one or more error correcting fields;
determining, based at least in part on the one or more MPDUs, whether to transmit the response;
in response to determining to transmit the response:
transmitting the response to the OTA medium after the second time;
otherwise:
not transmitting the response to the OTA medium after the second time.

4. The method of claim 3, further comprising:
in response to determining not to transmit the response:
additionally configuring the device to cancel the pre-configuration of the device to transmit the response.

5. The method of claim 4, wherein:
configuring the device to cancel the pre-configuration of the device to transmit the response is performed in advance of transmitting a signal field (L-SIG).

6. An apparatus for communication in a wireless network, the apparatus comprising one or more processors configured to perform one or more operations comprising:
receiving a first portion of a frame from an over the air (OTA) medium at a first time;
receiving a last portion of the frame from the OTA medium at a second time after the first time;
determining, at a third time after the first time and before the second time, based at least in part on the first portion of the frame, whether one or more conditions for transmitting a response are met; and
in response to determining that the one or more conditions for transmitting a response are met:
pre-configuring the apparatus to transmit the response before the second time; and
transmitting the response to the OTA medium after the second time;
otherwise:
ignoring the frame.

7. The apparatus of claim 6, wherein transmitting the response to the OTA medium is performed additionally in advance of an end of a frame space in which the last portion of the frame was received by at least a turnaround time required for the apparatus to switch from a receiving mode to a transmitting mode.

8. The apparatus of claim 6, wherein the one or more operations further comprise:
receiving one or more media access control (MAC) protocol data unit (MPDUs) of the frame from the OTA medium at or before the second time, the one or more MPDUs comprising one or more error correcting fields;
determining, based at least in part on the one or more MPDUs, whether to transmit the response; and
in response to determining to transmit the response:
transmitting the response to the OTA medium after the second time;
otherwise:
not transmitting the response to the OTA medium after the second time.

9. The apparatus of claim 8, wherein the one or more operations further comprise:
in response to determining not to transmit the response:
additionally configuring the apparatus to cancel the pre-configuration of the apparatus to transmit the response.

10. The apparatus of claim 9, wherein:
configuring the apparatus to cancel the pre-configuration of the apparatus to transmit the response is performed in advance of transmitting a signal field (L-SIG).

11. A method for communicating packets in a wireless communication network, the method comprising, at a device:
at a first slot time interval for an over the air (OTA) medium prior to a backoff counter for the device expiring, determining whether the OTA medium is busy;
in response to determining that the OTA medium at the first slot time interval is not busy:
determining information for transmission;
at a second slot time interval for the OTA medium with the backoff counter for the device expired, determining whether the OTA medium at the second slot time interval is busy;
pre-configuring the device to transmit the information for transmission independent of determining whether the OTA medium at the second slot time interval is busy; and
in response to determining that the OTA medium at the second slot time is not busy, transmitting to the OTA medium after an end of the second slot time interval; and
in response to determining that the OTA medium at the first slot time interval is busy, ignoring the first slot time interval.

12. The method of claim 11, wherein:
determining whether the OTA medium at the second slot time interval is busy is performed at a first time; and
pre-configuring the device to transmit the information for transmission is performed at a second time before the first time.

13. The method of claim 11, further comprising:
at the second slot time interval with the backoff counter for the device expired:
in response to determining that the OTA medium at the second slot time interval is busy, additionally configuring the device to cancel the pre-configuration of the device to transmit the information for transmission.

14. The method of claim 13, wherein:
configuring the device to cancel the pre-configuration of the device to transmit the information for transmission is performed in advance of the end of the second slot time interval.

15. The method of claim 11, wherein the first slot time interval is immediately preceding the second slot time interval.

16. The method of claim 11, wherein:
the wireless communication network implements Enhanced Distributed Channel Access (EDCA) function; and
the backoff counter for the device is determined by the EDCA function based on an access category corresponding to a user priority of the device.

17. A apparatus for communicating in a wireless communication network, the apparatus comprising one or more processors configured to perform one or more operations comprising:
at a first slot time interval for an over the air (OTA) medium prior to a backoff counter for the apparatus expiring, determining whether the OTA medium is busy;
in response to determining that the OTA medium at the first slot time interval is not busy:
determining information for transmission;
at a second slot time interval for the OTA medium with the backoff counter for the apparatus expired, determining whether the OTA medium at the second slot time interval is busy;
pre-configuring the apparatus to transmit the information for transmission independent of determining whether the OTA medium at the second slot time interval is busy; and
in response to determining that the OTA medium at the second slot time interval is not busy, transmitting to the OTA medium after an end of the second slot time interval; and
in response to determining that the OTA medium at the first slot time interval is busy, ignoring the first slot time interval.

18. The apparatus of claim 17, wherein:
determining whether the OTA medium at the second slot time interval is busy is performed at a first time; and
pre-configuring the apparatus to transmit the information for transmission is performed at a second time before the first time.

19. The apparatus of claim 16, wherein the one or more operations further comprise:
at the second slot time interval with the backoff counter for the apparatus expired:
in response to determining that the OTA medium at the second slot time interval is busy, additionally configuring the apparatus to cancel the pre-configuration of the apparatus to transmit the information for transmission.

20. The apparatus of claim 19, wherein:
configuring the apparatus to cancel the pre-configuration of the apparatus to transmit the information for transmission is performed in advance of the end of the second slot time interval.

21. The apparatus of claim 17, wherein the first slot time interval is immediately preceding the second slot time interval.

22. The apparatus of claim 17, wherein:
the wireless communication network implements Enhanced Distributed Channel Access (EDCA) function; and
the backoff counter for the apparatus is determined by the EDCA function based on an access category corresponding to a user priority of the apparatus.
